(19) United States
(12) Patent Application Publication
(10) Pub. No.: US 2016/0006189 A1
(43) Pub. Date: Jan. 7, 2016

(54) Organizing Device

(71) Applicant: Walter J. Morehead, Houston, TX (US)

(72) Inventor: Walter J. Morehead, Houston, TX (US)

(21) Appl. No.: 14/321,391

(22) Filed: Jul. 1, 2014

(51) Int. Cl. H01R 13/72; H01R 13/516

(52) U.S. Cl. CPC H01R 13/72; H01R 13/516

(57) ABSTRACT

An organizing device organizes cords of appliances and provides storage space for related accessories. The device includes a primary housing having a bottom wall and a perimeter wall coupled to and extending upwardly from the bottom wall. A plurality of slots is positioned in the primary housing. A plurality of reels is coupled to the primary housing and positioned in an interior space of the primary housing. A plurality of cords is provided each having a primary end coupled to an associated one of the reels. Each of the cords is extendable around the associated reel wherein a secondary end of each of the cords is selectively extendable from the associated reel through a selectable one of the slots. A plurality of electrical outlets each is coupled to an associated reel. The primary end of each of the cords is electrically couplable to an associated one of the electrical outlets.

### BACKGROUND OF THE DISCLOSURE

### Field of the Disclosure

The disclosure relates to storage devices and more particularly pertains to a new storage device for organizing cords of appliances and providing storage space for related accessories.

### SUMMARY OF THE DISCLOSURE

An embodiment of the disclosure meets the needs presented above by generally comprising a primary housing having a bottom wall and a perimeter wall coupled to and extending upwardly from the bottom wall. A plurality of slots is positioned in the primary housing. A plurality of reels is coupled to the primary housing and positioned in an interior space of the primary housing. A plurality of cords is provided each having a primary end coupled to an associated one of the reels. Each of the cords is extendable around the associated reel wherein a secondary end of each of the cords is selectively extendable from the associated reel through a selectable one of the slots. A plurality of electrical outlets each is coupled to an associated reel. The primary end of each of the cords is electrically couplable to an associated one of the electrical outlets.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an organizing device according to an embodiment of the disclosure.

FIG. 2 is a side view of an embodiment of the disclosure.

FIG. 3 is a top view of an embodiment of the disclosure.

FIG. 4 is a partial cut-away front view of an embodiment of the disclosure.

FIG. 5 is a cross-sectional view of an embodiment of the disclosure taken along line 5-5 of FIG. 4.

FIG. 6 is a top front side perspective view of an embodiment of the disclosure in use.

### DESCRIPTION OF THE PREFERRED EMBODIMENT

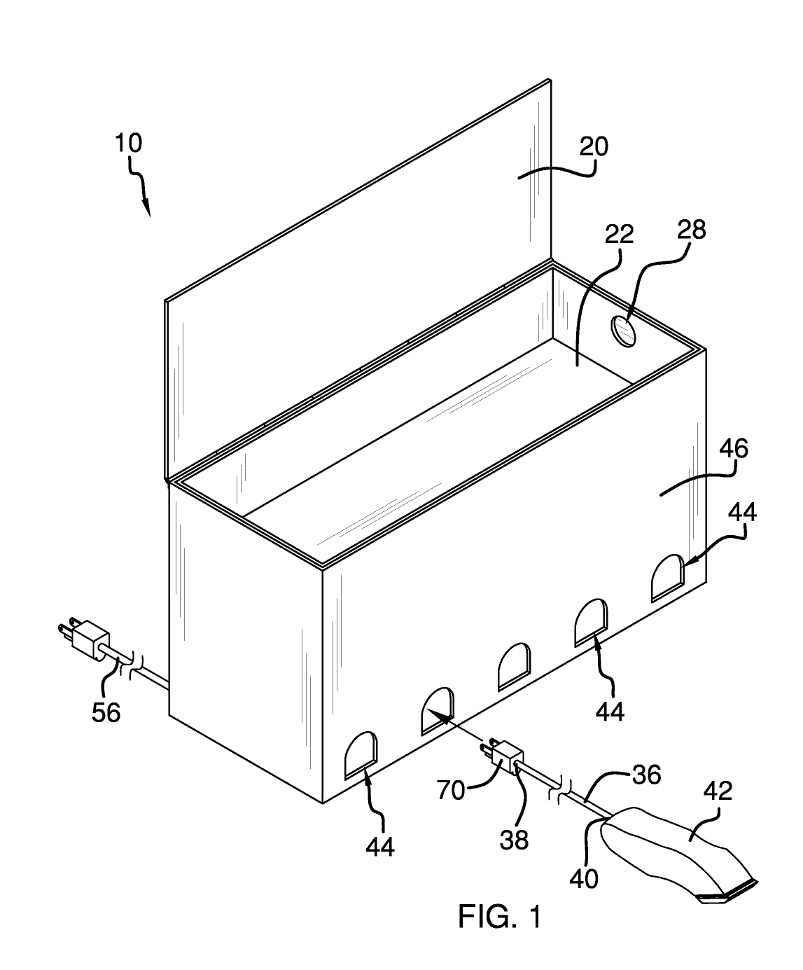

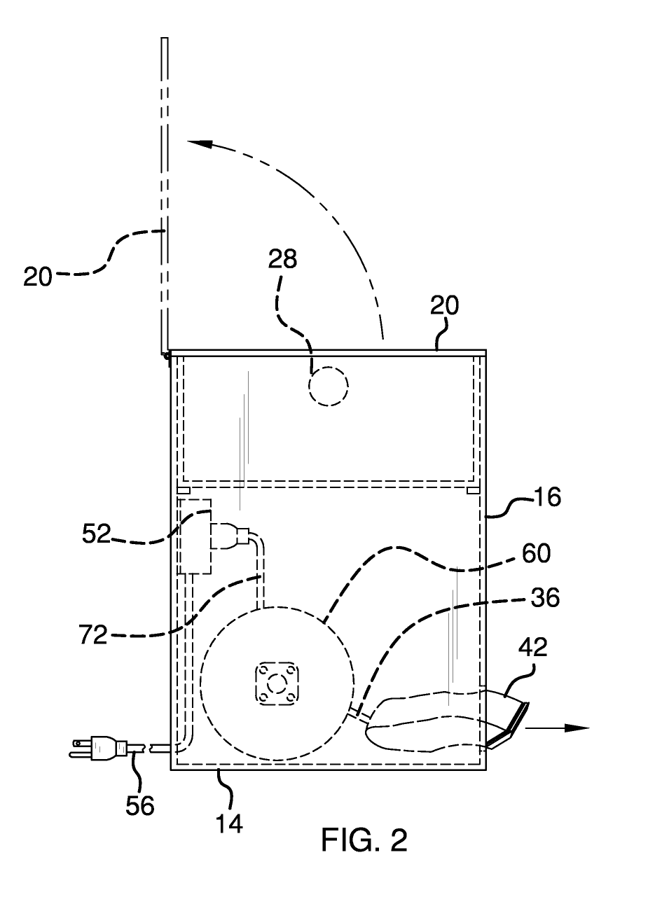

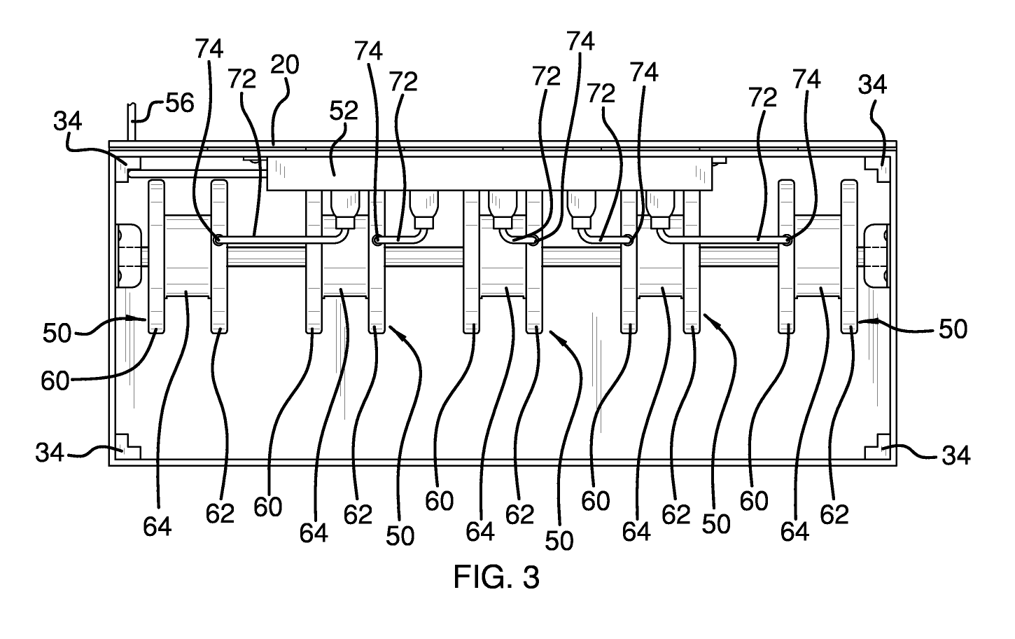

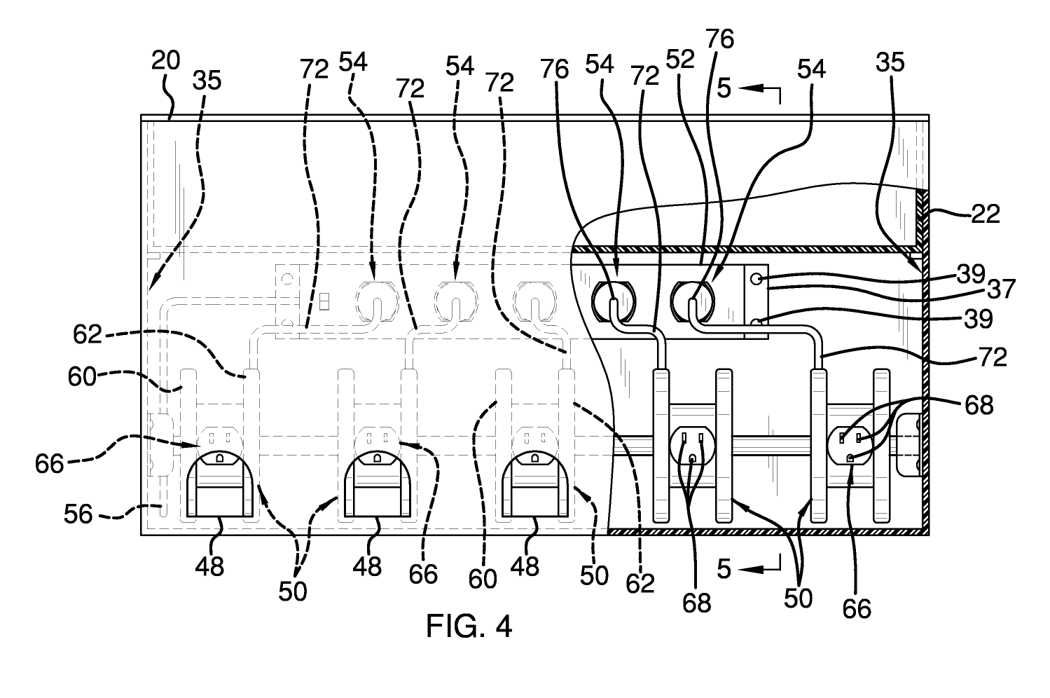

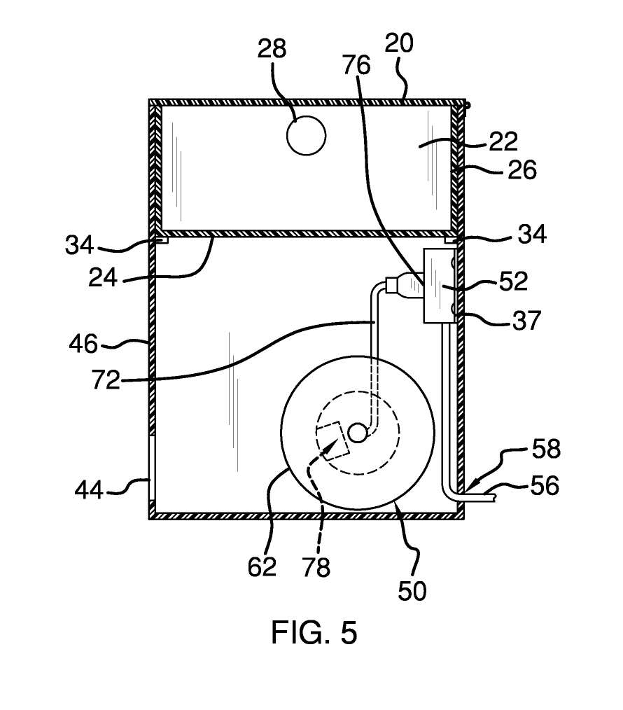

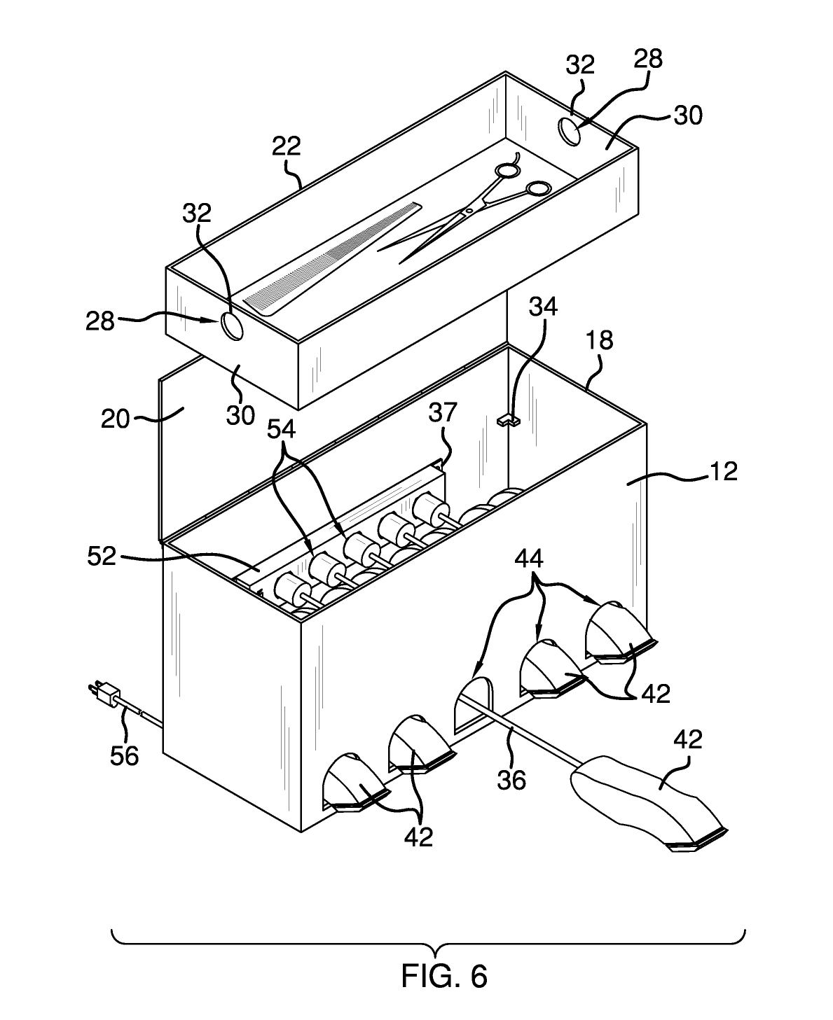

With reference now to the drawings, and in particular to FIGS. 1 through 6 thereof, a new storage device embodying the principles and concepts of an embodiment of the disclosure and generally designated by the reference numeral 10 will be described.

As best illustrated in FIGS. 1 through 6, the organizing device 10 generally comprises a primary housing 12 having a bottom wall 14 and a perimeter wall 16 coupled to and extending upwardly from the bottom wall 14. A top edge 18 of the perimeter wall 16 defines an access opening into an interior space of the primary housing 12. A lid 20 is hingedly coupled to the primary housing 12. The lid 20 is selectively positionable to close the access opening. The primary housing 12 and the lid 20 may each be constructed from plastic, wood, fiberglass or the like. The device 10 may have a height between approximately 15.0 cm and 35.0 cm, a length between approximately 30.0 cm and 60.0 cm, and a width between approximately 12.0 cm and 20.0 cm. The housing 12 may be mountable to a wall, roof or other structure using conventional fastening means, such as a mounting plate and screws. Alternatively, the housing 12 may be portable to allow the device 10 to be moved where needed.

A tray 22 is removably positionable within the interior space of the primary housing 12. The tray 22 has a lower wall 24 and a peripheral wall 26 coupled to and extenidng upwardly from the lower wall 24. The tray 22 may be used to store accessories related to a particular use, such as hairstyling accessories, construction accessories or the like. The peripheral wall 26 of the tray 22 has a pair of openings 28 positioned therein. Each of the openings 28 is positioned on opposite sides 30 of the peripheral wall 26 and defines a pair of handles 32 to facilitate lifting and carrying of the tray 22. A plurality of flanges 34 is coupled to and exends from an interior surface 35 of the perimeter wall 16. Each of the flanges 34 supports the tray 22 when the tray 22 is positioned within the interior space of the primary housing 12. The flanges 34 are positioned nearer to the top edge 18 than to the bottom wall 14 of the primary housing 12.

A plurality of slots 44 is positioned in an associated side 46 of the perimeter wall 16. A plurality of reels 50 is coupled to the primary housing 12 and positioned in the interior space of the primary housing 12. Each of the reels 50 is generally conventional and may comprise a pair of end caps 60, 62 and a middle section 64 coupled to and extending between each of the end caps 60, 62. Each of the reels 50 may be constructed from a rigid material, such as plastic or the like. A plurality of cords 36 is provided, each having a primary end 38 coupled to an associated one of the reels 50. Each of the cords 36 is coupled, either fixedly or detachably, to an appliance 42, such as a blow dryer, power tool or the like. Each of the cords 36 is extendable around the associated reel 50 wherein a secondary end 40 of each of the cords 36 is selectively extendable from the associated reel 50 through a selectable one of the slots 44. Each of the slots 44 has a top edge 48 that may be convexly arcuate. The slots 44 may be horizontally, vertically or even diagonally aligned relative to each other.

A plurality of electrical outlets 66 is provided. Each of the electrical outlets 66 is coupled to an associated reel 50 and is positioned in the interior of the associated reel 50. More particularly, each of the electrical outlets 66 is coupled to the middle section 64 of the associated reel 50. Each of the electrical outlets 66 may be positioned in a recessed area of a respective one of the middle sections 64. Each of the electrical outlets 66 has a plurality of female receptacles 68. Each of the female receptacles 68 is configured to removably receive a male plug 70 of the appliance 42 to supply an electrical current to the appliance 42. The electrical outlets 66 may be of any conventional design.

A power strip housing 52 is coupled to the primary housing 12. The power strip housing 52 is mounted to the interior surface 35 of the perimeter wall 16 in a conventional manner, such as by using mounting plates 37 and fasteners 39. A plurality of electrical outlet receptacles 54 is disposed within the power strip housing 52. A plurality of electrical cords 72 is provided each having a first end 74 that is electrically coupled to an associated one of the electrical outlets 66. Each of the electrical cords 72 has a second end 76 coupled to an associated one of the electrical outlet receptacles 54. Each of the electrical cords 72 extends from an associated one of the reels 50 and has the first end 74 attached to a stationary portion on the associated reel 50 such that extending and retracting the cords 36 into and out of the primary housing 12 will not cause the electrical cords 72 to unplug from the electrical outlet receptacles 54. The electrical cords 72 may be of any conventional design.

A power cord 56 is coupled to the power strip housing 52. The power cord 56 is electrically couplable to the electrical outlet receptacles 54 to provide power to the appliances 42 electrically coupled to the electrical outlets 66. A hole 58 is positioned in an associated side 46 of the perimeter wall 16. The power cord 56 extends outwardly of the primary housing 12 through the hole 58 and may be retractable into and out of the primary housing 12 through the hole 58 in a generally conventional manner.

In use, as stated above and shown in the Figures, various appliances 42 are selected each associated with a particular task, such as cutting and styling a person's hair. The primary end 38 of each cord 36 of the associated appliance 42 is electrically coupled to an associated one of the electrical outlets 66. The secondary end 40 of each cord 36 is extended outwardly of the primary housing 12 through a selectable slot 44. The power cord 56 is plugged into an external electrical outlet and provides power to the appliances 42 through the electrical outlet receptacles 54. In this manner, the device 10 prevents tangling of and damage to the cords 36, while also preventing a person from dropping the appliances 42. Accessories, such as screws, scissors or the like may be positioned within the tray 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An organizing device comprising:
a primary housing having a bottom wall and a perimeter wall coupled to and extending upwardly from said bottom wall;
a plurality of slots positioned in said primary housing;
a plurality of reels coupled to said primary housing, each of said reels being positioned in an interior space of said primary housing;
a plurality of cords, each of said cords having a primary end coupled to an associated one of said reels, each of said cords being extendable around said associated reel wherein a secondary end of each of said cords is selectively extendable from said associated reel through a selectable one of said slots; and
a plurality of electrical outlets, each of said electrical outlets being coupled to an associated reel and being positioned in an interior of said associated reel, said primary end of each of said cords being electrically couplable to an associated one of said electrical outlets.

2. The device of claim 1, further comprising:
a top edge of said perimeter wall defining an access opening into said interior space of said primary housing; and
a lid hingedly coupled to said primary housing, said lid being selectively positionable to close said access opening.

3. The device of claim 1, further comprising a tray being removably positionable within said interior space of said primary housing, said tray having a lower wall and a peripheral wall coupled to and extending upwardly from said lower wall.

4. The device of claim 3, further comprising a plurality of flanges coupled to and extending from an interior surface of said perimeter wall, each of said flanges supporting said tray when said tray is positioned within said interior space of said primary housing.

5. The device of claim 3, further comprising said peripheral wall of said tray having a pair of openings positioned therein, each of said openings being positioned on opposite sides of said peripheral wall and defining a pair of handles to facilitate lifting and carrying of said tray.

6. The device of claim 1, further comprising each of said cords being spaced from an adjacently positioned one of said cords.

7. The device of claim 1, further comprising a plurality of electrical cords each having a first end electrically coupled to an associated one of said electrical outlets.

8. The device of claim 7, further comprising:
a power strip housing coupled to said primary housing and positioned within said interior space of said primary housing; and
a plurality of electrical outlet receptacles being disposed within said power strip housing, each of said electrical cords having a second end coupled to an associated one of said electrical outlet receptacles.

9. The device of claim 7, further comprising said first end of each of said electrical cords being attached to a stationary portion on said associated reel.

10. The device of claim 8, further comprising:
a power cord coupled to said power strip housing, said power cord being electrically couplable to said electrical outlet receptacles; and
a hole positioned in said housing, said power cord extending outwardly of said primary housing through said hole.

11. The device of claim 9, further comprising each of said slots having a top edge, said top edge of each of said slots being convexly arcuate.

12. The device of claim 1, further comprising each of said reels comprising a pair of end caps and a middle section coupled to and extending between each of said end caps.

13. The device of claim 12, further comprising each of said electrical outlets being coupled to said middle section of said associated reel.

14. The device of claim 13, further comprising each of said electrical outlets being positioned in a recessed area of a respective one of said middle sections.

15. The device of claim 1, further comprising each of said electrical outlets having a plurality of female receptacles.

16. An organizing device comprising:
a primary housing having a bottom wall and a perimeter wall coupled to and extending upwardly from said bottom wall, a top edge of said perimeter wall defining an access opening into an interior space of said primary housing;
a lid hingedly coupled to said primary housing, said lid being selectively positionable to close said access opening;
a tray being removably positionable within said interior space of said primary housing, said tray having a lower wall and a peripheral wall coupled to and extenidng upwardly from said lower wall, said peripheral wall of said tray having a pair of openings positioned therein, each of said openings being positioned on opposite sides of said peripheral wall and defining a pair of handles to facilitate lifting and carrying of said tray;
a plurality of flanges coupled to and extending from an interior surface of said perimeter wall, each of said flanges supporting said tray when said tray is positioned within said interior space of said primary housing, said flanges being positioned nearer to said top edge than to said bottom wall;
a plurality of slots positioned in said primary housing, each of said slots being positioned in an associated side of said perimeter wall, each of said slots having a top edge, said top edge of each of said slots being convexly arcuate;
a plurality of reels coupled to said primary housing, each of said reels being positioned in said interior space of said primary housing, each of said reels comprising a pair of end caps and a middle section coupled to and extending between each of said end caps;
a plurality of cords, each of said cords having a primary end coupled to an associated one of said reels, each of said cords being extendable around said associated reel wherein a secondary end of each of said cords is selectively extendable from said associated reel through a selectable one of said slots, each of said cords being spaced from an adjacently positioned one of said cords;
a plurality of electrical outlets, each of said electrical outlets being coupled to an associated reel and being positioned in an interior of said associated reel, said primary end of each of said cords being electrically couplable to an associated one of said electrical outlets, each of said end caps being coupled to said middle section of said associated reel, each of said electrical outlets being positioned in a recessed area of a respective one of said middle sections, each of said electrical outlets having a plurality of female receptacles;
a plurality of electrical cords each having a first end electrically coupled to an associated one of said electrical outlets, said first end of each of said electrical cords being attached to a stationary portion on said associated reel;
a power strip housing being coupled to said primary housing, said power strip housing being positioned within said interior space of said primary housing, said power strip housing being mounted to said interior surface of said perimeter wall;
a plurality of electrical outlet receptacles being disposed within said power strip housing, each of said electrical cords having a second end coupled to an associated one of said electrical outlet receptacles;
a power cord coupled to said power strip housing, said power cord being electrically couplable to said electrical outlet receptacles; and
a hole positioned in an associated side of said perimeter wall, said power cord extending outwardly of said primary housing through said hole.
